(19) United States
(12) Patent Application Publication
(10) Pub. No.: US 2025/0386321 A1
(43) Pub. Date: Dec. 18, 2025

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Hao WANG, Dongguan (CN); Shichang ZHANG, Dongguan (CN); Teng MA, Dongguan (CN)

(21) Appl. No.: 19/319,985

(22) Filed: Sep. 5, 2025

Related U.S. Application Data
(63) Continuation of application No. PCT/CN2023/093963, filed on May 12, 2023.

(51) Int. Cl. H04W 64/00; H04W 72/25

(52) U.S. Cl. CPC H04W 64/00; H04W 72/25

(57) ABSTRACT

A wireless communication method includes: transmitting, by a first terminal device, a first SL PRS in a first slot, where the first slot includes second-stage SCI, and the second-stage SCI includes transmission configuration information of the first SL PRS.

### CROSS-REFERENCE TO RELATED APPLICATION

This application is a Continuation Application of International Application No. PCT/CN2023/093963 filed on May 12, 2023, which is incorporated herein by reference in its entirety.

### TECHNICAL FIELD

The present disclosure relates to the field of communication technology, and in particular, to a wireless communication method and a terminal device.

### BACKGROUND

In sidelink-based positioning technology, a terminal device needs to transmit a sidelink positioning reference signal (SL PRS) to achieve a positioning function. The SL PRS transmitted by different terminal devices may be different in time domain, frequency domain and code domain. Therefore, how to ensure other terminal devices to correctly receive the SL PRS is an issue that needs to be studied.

### SUMMARY

The present disclosure provides a wireless communication method and a terminal device.

In a first aspect, a wireless communication method is provided and includes: transmitting, by a first terminal device, a first sidelink positioning reference signal (SL PRS) in a first slot; where the first slot includes second-stage sidelink control information (SCI), and the second-stage SCI includes transmission configuration information of the first SL PRS.

In a second aspect, a wireless communication method is provided and includes: receiving, by a second terminal device, a first sidelink positioning reference signal (SL PRS) in a first slot; where the first slot includes second-stage sidelink control information (SCI), and the second-stage SCI includes transmission configuration information of the first SL PRS.

In a third aspect, a terminal device is provided. The terminal device is a first terminal device and the first terminal device includes: a communication module, configured to transmit a first sidelink positioning reference signal (SL PRS) in a first slot; where the first slot includes second-stage sidelink control information (SCI), and the second-stage SCI includes transmission configuration information of the first SL PRS.

In a fourth aspect, a terminal device is provided. The terminal device is a second terminal device and the second terminal device includes: a communication module, configured to receive a first sidelink positioning reference signal (SL PRS) in a first slot; where the first slot includes second-stage sidelink control information (SCI), and the second-stage SCI includes transmission configuration information of the first SL PRS.

In a fifth aspect, a terminal device is provided and includes a transceiver, a memory and a processor. The memory is configured to store a program, and the processor is configured to call the program in the memory and control the transceiver to receive or transmit a signal, to enable the terminal device to perform the method according to the first aspect or the second aspect.

In a sixth aspect, an apparatus is provided and includes a processor configured to call a program from a memory, to enable the apparatus to perform the method according to the first aspect or the second aspect.

In a seventh aspect, a chip is provided and includes a processor configured to call a program from a memory, to enable a device equipped with the chip to perform the method according to the first aspect or the second aspect.

In an eighth aspect, a non-transitory computer-readable storage medium is provided, on which a program is stored, where the program enables a computer to perform the method according to the first aspect or the second aspect.

In a ninth aspect, a computer program product is provided and includes a program, where the program enables a computer to perform the method according to the first aspect or the second aspect.

In a tenth aspect, a computer program is provided, and the computer program enables a computer to perform the method according to the first aspect or the second aspect.

### BRIEF DESCRIPTION OF THE DRAWINGS

FIG. 1 is an example diagram illustrating of a system architecture of a wireless communication system to which embodiments of the present disclosure may be applied.

FIG. 2 is an example diagram illustrating a scenario of sidelink communication within network coverage.

FIG. 3 is an example diagram illustrating a scenario of sidelink communication with partial network coverage.

FIG. 4 is an example diagram illustrating a scenario of sidelink communication outside network coverage.

FIG. 5 is an example diagram illustrating a scenario of sidelink communication based on a central control node.

FIG. 6 is an example diagram of a broadcast-based sidelink communication manner.

FIG. 7 is an example diagram of a unicast-based sidelink communication manner.

FIG. 8 is an example diagram of a multicast-based sidelink communication manner.

FIG. 9A is an example diagram illustrating a slot structure utilized by a sidelink communication system.

FIG. 9B is an example diagram of another slot structure utilized by the sidelink communication system.

FIG. 10 is a schematic diagram of a possible structure of SCI format 2-C.

FIG. 11 is a schematic diagram of another possible structure of SCI format 2-C.

FIG. 12 is a flowchart of a wireless communication method provided in an embodiment of the present disclosure.

FIG. 13 is a comparison diagram of the SCI format 2-C provided in an embodiment of the present disclosure and the SCI format 2-C illustrated in FIG. 11.

FIG. 14 is a comparison diagram between the SCI format 2-C provided in another embodiment of the present disclosure and the SCI format 2-C illustrated in FIG. 11.

FIG. 15 is a schematic diagram of a structure of a terminal device provided in an embodiment of the present disclosure.

FIG. 16 is a schematic diagram of a structure of a terminal device provided in another embodiment of the present disclosure.

FIG. 17 is a schematic diagram of a structure of an apparatus provided in an embodiment of the present disclosure.

### DETAILED DESCRIPTION

### Communication System Architecture

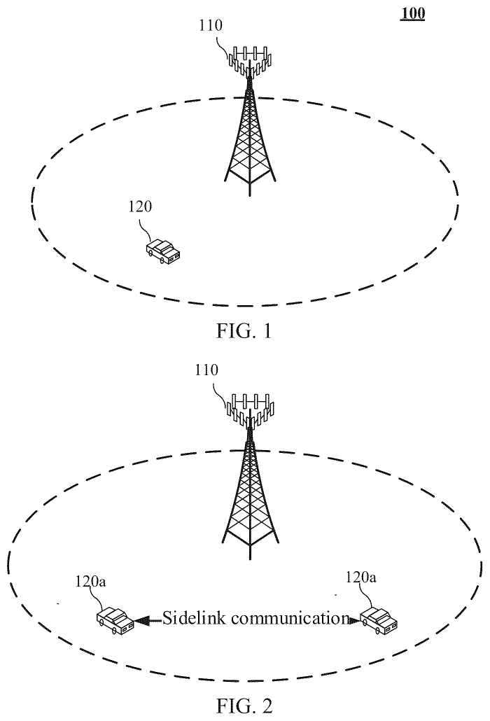

FIG. 1 is an example diagram illustrating of a system architecture of a wireless communication system 100 to which embodiments of the present disclosure may be applied. The wireless communication system 100 may include a network device 110 and a terminal device 120. The network device 110 may be a device that communicates with the terminal device 120. The network device 110 may provide communication coverage for a specific geographical area, and may communicate with the terminal device 120 located within the coverage area.

FIG. 1 exemplarily illustrates a network device and a terminal device. Optionally, the wireless communication system 100 may include one or more network devices 110 and/or one or more terminal devices 120. For one network device 110, the one or more terminal devices 120 may all be located within the network coverage range of the network device 110, or may all be located outside the network coverage range of the network device 110, or may be located partly within the network coverage range of the network device 110 and partly outside the network coverage range of the network device 110, which is not limited in the embodiments of the present disclosure.

Optionally, the wireless communication system 100 may also include other network entities such as a network controller, a mobility management entity, which is not limited in the embodiments of the present disclosure.

It should be understood that the technical solution of the embodiments of the present disclosure may be applied to various communication systems, such as a fifth-generation (5th generation, 5G) system or a new radio (NR) system, a long term evolution (LTE) system, an LTE frequency division duplex (FDD) system, an LTE time division duplex (TDD) system. The technical solution provided by the present disclosure may also be applied to future communication systems, such as a sixth-generation (6G) mobile communication system, a satellite communication system.

In the embodiments of the present disclosure, the terminal device may also be referred to as a user equipment (UE), an access terminal, a user unit, a user station, a mobile site, a mobile station (MS), a mobile terminal (MT), a remote station, a remote terminal device, a mobile device, a user terminal, a wireless communication device, a user agent or a user apparatus. In the embodiments of the present disclosure, the terminal device may refer to a device that provides voice and/or data connectivity to a user, and may be used to connect people, objects and machines, such as a handheld device or in-vehicle device with a wireless connection function. In the embodiments of the present disclosure, the terminal device may be a mobile phone, a tablet computer (Pad), a laptop computer, a handheld computer, a mobile Internet device (MID), a wearable device, a vehicle, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. For example, the terminal device may act as a scheduling entity that provides sidelink signals between terminal devices in vehicle-to-everything (V2X) communication or device-to-device (D2D) communication. For example, a cellular phone and a car may communicate with each other by using sidelink signals. A cellular phone and a smart home device may communicate with each other without relaying communication signals via a base station. Optionally, the terminal device may be configured to act as a base station.

In the embodiments of the present disclosure, the network device may be a device used for communicating with a terminal device, and the network device may also be referred to as an access network device or a wireless access network device, e.g., a base station. In the embodiments of the present disclosure, the network device may refer to a radio access network (RAN) node (or device) that connects the terminal device to a wireless network. The base station may broadly cover the following various names, or may be replaced with the following names, such as: a NodeB, an evolved NodeB (eNB), a next generation NodeB (gNB), a relay station, an access point (AP), a transmitting and receiving point (TRP), a transmission point (TP), a master station (MeNB), a secondary station (SeNB), a multi-standard radio (MSR) node, a home base station, a network controller, an access node, a wireless node, an access point, a transmission node, a transceiver node, a base band unit (BBU), a remote radio unit (RRU), an active antenna unit (AAU), a remote radio head (RRH), a central unit (CU), a distributed unit (DU), a positioning node, etc. The base station may be a macro base station, a micro base station, a relay node, a donor node, or similar entities, or a combination thereof. The base station may also refer to a communication module, a modem or a chip configured to be set in the aforementioned devices or apparatuses. The base station may also be a mobile switching center, a device that performs functions of the base station in device-to-device (D2D) communication, vehicle-to-everything (V2X) communication, and machine-to-machine (M2M) communication, a network-side device in a 6G network, and a device that performs functions of the base station in a future communication system, etc. The base station may support networks with the same or different access technologies. The specific technologies used by the network device and the specific device forms of the network device are not limited in the embodiments of the present disclosure.

The base station may be immobile or mobile. For example, a helicopter or a drone may be configured to act as a mobile base station, and one or more cells may move based on the location of the mobile base station. In other examples, the helicopter or the drone may be configured to act as a device communicating with another base station.

In some deployments, the network device in the embodiments of the present disclosure may refer to a CU or a DU, or the network device includes a CU and a DU. The gNB may also include an AAU.

The network device and the terminal device may be deployed on land, which includes indoor or outdoor, in handheld or in-vehicle; may also be deployed on water; may also be deployed on an airplane, a balloon and a satellite in the air. The scenarios in which the network device and terminal device are located are not limited in the embodiments of the present disclosure.

### Sidelink Communication Under Different Network Coverage Conditions

Sidelink communication refers to a communication technology based on a sidelink. For example, the sidelink communication may be device to device (D2D) communication or vehicle to everything (V2X) communication. In a traditional cellular system, communication data is received or transmitted between a terminal device and a network device, while the sidelink communication supports direct transmission of communication data between terminal devices. Compared with traditional cellular communication, direct transmission of communication data between terminal devices may have higher spectrum efficiency and lower transmission delay. For example, the V2X system uses sidelink communication technology.

In sidelink communication, according to the network coverage conditions of the terminal devices, the sidelink communication may be classified into sidelink communication within network coverage, sidelink communication with partial network coverage, and sidelink communication outside network coverage.

FIG. 2 is an example diagram illustrating a scenario of sidelink communication within network coverage. In the scenario illustrated in FIG. 2, two terminal devices 120a are both within the coverage range of the network device 110. Therefore, the two terminal devices 120a are both capable of receiving configuration signaling of the network device 110 (the configuration signaling may also be replaced with configuration information in the present disclosure), and determine sidelink configuration according to the configuration signaling of the network device 110. After the two terminal devices 120a have performed sidelink configuration, the sidelink communication may be performed on a sidelink.

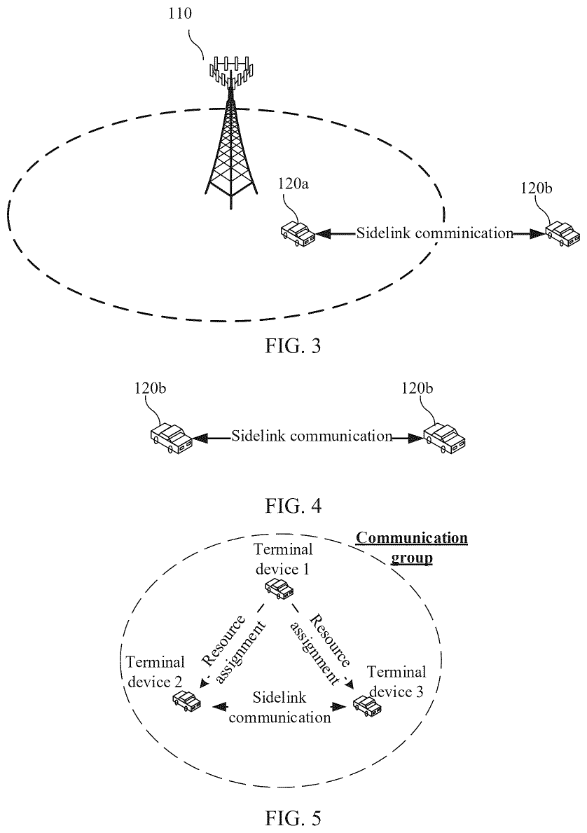

FIG. 3 is an example diagram illustrating a scenario of sidelink communication with partial network coverage. In the scenario illustrated in FIG. 3, the terminal device 120a performs sidelink communication with the terminal device 120b. The terminal device 120a is located within the coverage range of the network device 110, then the terminal device 120a may receive configuration signaling of the network device 110 and determine sidelink configuration according to the configuration signaling of the network device 110. The terminal device 120b is located outside the network coverage range and cannot receive the configuration signaling of the network device 110. In this case, the terminal device 120b may determine the sidelink configuration according to preconfigured information and/or information carried in a physical sidelink broadcast channel (PSBCH) transmitted by the terminal device 120a within the network coverage range. After both the terminal device 120a and the terminal device 120b have performed sidelink configuration, the sidelink communication may be performed on a sidelink.

FIG. 4 is an example diagram illustrating a scenario of sidelink communication outside network coverage. In the scenario illustrated in FIG. 4, two terminal devices 120b are both located outside the network coverage range. In this case, the two terminal devices 120b are both capable of determining sidelink configuration according to preconfigured information. After the two terminal devices 120b have performed sidelink configuration, the sidelink communication may be performed on a sidelink.

### Sidelink Communication Based on a Central Control Node

FIG. 5 is an example diagram illustrating a scenario of sidelink communication based on a central control node. In the scenario of sidelink communication, a plurality of terminal devices may form a communication group, and there is a central control node in the communication group. The central control node may be a terminal device in the communication group (e.g., a terminal device 1 in FIG. 5), and the terminal device may also be referred to as a cluster header (CH) terminal device. The central control node may be responsible for completing one or more of the following functions: establishment of a communication group, joining and leaving of group members of the communication group, coordinating resources within the communication group, assigning sidelink transmission resources for other terminal devices, receiving sidelink feedback information from other terminal devices, and coordinating resources with other communication groups.

### Sidelink Communication Mode

Some standards or protocols (such as third Generation Partnership Project (3GPP)) define two modes of sidelink communication: a first mode and a second mode.

In the first mode, a resource of a terminal device (the resource mentioned in the present disclosure may also be referred to as a transmission resource, such as time-frequency resource) is assigned by a network device. The terminal device may transmit data on the sidelink according to the resource assigned by the network device. The network device may assign, to the terminal device, a resource for a single transmission, or may assign, to the terminal device, a resource for a semi-persistent transmission. The first mode may be applied to a scenario with the coverage of network device, such as the scenario illustrated in FIG. 2 above. In the scenario illustrated in FIG. 2, the terminal device 120a is located within the network coverage range of the network device 110, and thus the network device 110 may assign, to the terminal device 120a, a resource for being used in the sidelink transmission process.

In the second mode, the terminal device may autonomously select one or more resources from a resource pool (RP). Then, the terminal device may perform sidelink transmission according to the selected resource. For example, in the scenario illustrated in FIG. 4, the terminal device 120b is located outside the cell coverage range. Therefore, the terminal device 120b may autonomously select resources for sidelink transmission from a preconfigured resource pool. Alternatively, in the scenario illustrated in FIG. 2, the terminal device 120a may also autonomously select one or more resources for sidelink transmission from a resource pool configured by the network device 110.

### Data Transmission Manner of Sidelink Communication

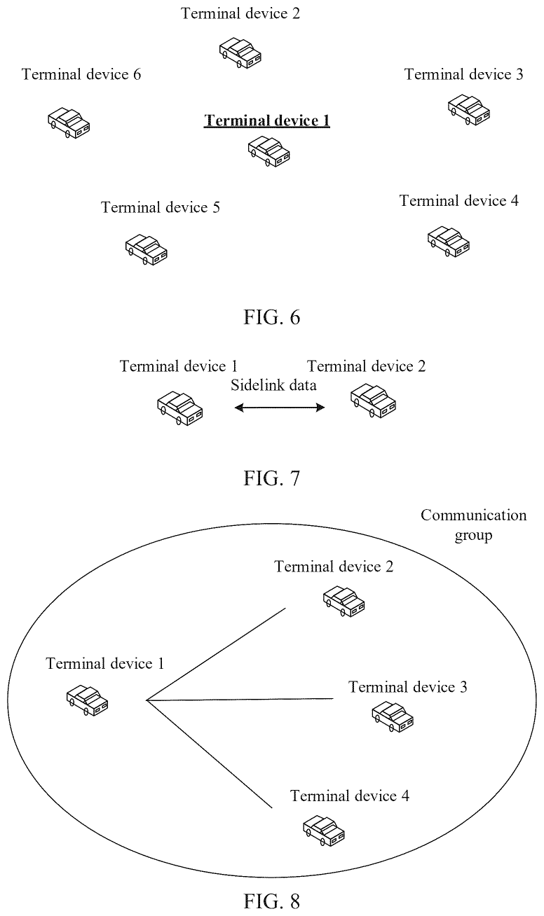

Some sidelink communication systems (e.g., long term evolution vehicle to everything (LTE-V2X)) support a data transmission manner based on broadcast (hereinafter referred to as broadcast transmission). For the broadcast transmission, a receiving terminal may be any terminal device around a transmitting terminal. Taking FIG. 6 as an example, a terminal device 1 is the transmitting terminal, and the receiving terminal corresponding to the transmitting terminal is any terminal device around the terminal device 1, such as a terminal device 2 to a terminal device 6 in FIG. 6.

In addition to the broadcast transmission, some communication systems also support a data transmission manner based on unicast (hereinafter referred to as unicast transmission) and/or a data transmission manner based on multicast (hereinafter referred to as multicast transmission). For example, new radio vehicle to everything (NR-V2X) aims to support autonomous driving. The autonomous driving imposes higher requirements on data interaction between vehicles. For example, the data interaction between vehicles requires higher throughput, lower latency, higher reliability, a larger coverage range, a more flexible resource assignment method, etc. Therefore, in order to improve the performance of data interaction between vehicles, the NR-V2X introduces the unicast transmission and the multicast transmission.

For the unicast transmission, the receiving terminal generally has only one terminal device. Taking FIG. 7 as an example, the unicast transmission is performed between a terminal device 1 and a terminal device 2. The terminal device 1 may be a transmitting terminal, and the terminal device 2 may be a receiving terminal, or the terminal device 1 may be a receiving terminal, and the terminal device 2 may be a transmitting terminal.

For the multicast transmission, the receiving terminal may be a terminal device within a communication group, or the receiving terminal may be a terminal device within a certain transmission distance. Taking FIG. 8 as an example, a terminal device 1, a terminal device 2, a terminal device 3 and a terminal device 4 constitute a communication group. If the terminal device 1 transmits data, other terminal devices (the terminal device 2 to the terminal device 4) in the communication group may all be receiving terminals.

### Slot Structure of Sidelink Communication

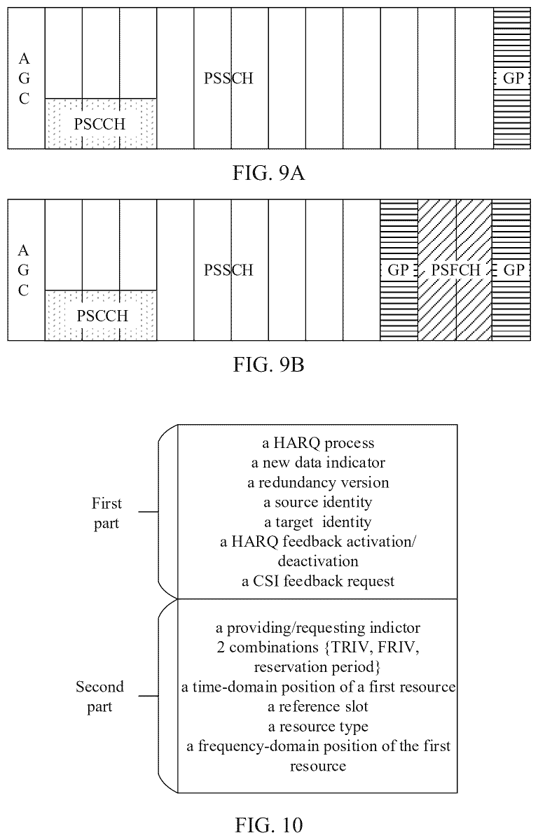

A communication system may define a frame, a subframe or a slot structure for sidelink communication. Some sidelink communication systems define various slot structures. For example, an NR-based sidelink communication system (NR SL) defines two slot structures. One of the two slot structures exclude a physical sidelink feedback channel (PSFCH), as illustrated in FIG. 9A; the other of the two slot structures includes the PSFCH, as illustrated in FIG. 9B.

A physical sidelink control channel (PSCCH) in the NR SL may take the second sidelink symbol of the slot as a starting position in time domain, and the PSCCH may occupy 2 or 3 symbols in the time domain (the symbols mentioned here may all refer to orthogonal frequency division multiplexing (OFDM) symbols). The PSCCH may occupy a plurality of physical resource blocks (PRBs) in frequency domain. For example, the number of PRBs occupied by the PSCCH may be selected from the following values: {10, 12, 15, 20, 25}.

In order to reduce the complexity of blind detection performed by a terminal device on the PSCCH, generally, only one number of symbols and one number of PRBs are configured for the PSCCH in a resource pool. In addition, since the NR SL uses a sub-channel as the minimum granularity for physical sidelink shared channel (PSSCH) resource assignment, the number of PRBs occupied by the PSCCH must be less than or equal to the number of PRBs included in a sub-channel in the resource pool.

As illustrated in FIG. 9A, for a slot structure excluding the PSFCH, a PSSCH in the NR SL may take the second sidelink symbol of the slot as a starting position in time domain. The last sidelink symbol in the slot is used as a guard period (GP), and remaining symbols may map the PSSCH, where the guard period may also be referred to as a guard symbol. The first sidelink symbol in the slot may be a repetition of the second sidelink symbol. Generally speaking, a terminal device as a receiving uses the first sidelink symbol as a symbol for performing automatic gain control (AGC). Therefore, the data transmitted in the first sidelink symbol is generally not used for data demodulation. The PSSCH may occupy K sub-channels in frequency domain, and each sub-channel may include M consecutive PRBs (values of K and M may be predefined by a protocol, or preconfigured, or configured by the network device, or depend on the implementation of the terminal device).

FIG. 9B illustrates a slot structure including the PSFCH, and FIG. 9B schematically illustrates positions of symbols occupied by the PSFCH, the PSCCH, and the PSSCH in a slot. The main difference between the slot structure in FIG. 9B and the slot structure in FIG. 9A is that a second-to-last symbol and the third-to-last symbol in the slot in FIG. 9B are used for transmitting the PSFCH, and in addition, one symbol earlier than the symbol used for transmitting the PSFCH is also used as GP (or guard symbol). It can be seen from the slot structure illustrated in FIG. 9B that in a slot, the last symbol is used as GP, a second-to-last symbol is used for PSFCH transmission, and the data transmitted in the third-to-last symbol is the same as the data of the second-to-last symbol used for PSFCH transmission. That is, the third-to-last symbol is used as the symbol for performing the AGC, and the fourth-to-last symbol has the same function as the last symbol and is also used as GP. In addition, the first symbol in the slot is used as AGC, the data transmitted in the first symbol is the same as the data transmitted in the second symbol in the slot, the PSCCH occupies 3 symbols, and the remaining symbols are available for PSSCH transmission.

### First-Stage Sidelink Control Information (SCI)

The first-stage SCI may be carried by a PSCCH. A format of the first-stage SCI may be SCI 1-A. The first-stage SCI may be used to indicate information related to sidelink scheduling and channel sensing. The information related to sidelink scheduling and channel sensing may include, for example, one or more of following information: a priority for scheduling data, frequency-domain resource assignment, time-domain resource assignment, reference signal pattern of a PSSCH, a format of the second stage (2nd-stage) SCI, a code rate offset of the 2nd-stage SCI, a number of PSSCH demodulation reference signal (DMRS) ports, a modulation and coding scheme (MCS), an MCS table indication, a number of symbols of the PSFCH, a resource reservation period, and a reserved bit. In the above indication field, a size of the “second-stage SCI Format” field is 2 bits, “00” represents SCI format 2-A, “01” represents SCI format 2-B, “10” represents SCI format 2-C, and “11” is a reserved value for a future version.

### Second-stage SCI

Currently, there are three SCI formats of the second-stage SCI, namely SCI format 2-A, SCI format 2-B and SCI format 2-C. The SCI format 2-A and the SCI format 2-B may be used for decoding of sidelink data in a PSSCH. The SCI format 2-C is introduced to support a resource selection mechanism that is based on coordination between terminal devices (or referred to as inter-UE coordination) in the second mode (a mode in which the terminal device autonomously selects a resource). In addition, the SCI format 2-C may also carry information used for decoding of the sidelink data in the PSSCH. Therefore, the SCI format 2-C includes two parts. A first part is information related to decoding of sidelink data in the PSSCH (or public information related to decoding). The information related to decoding may include one or more of following information: a hybrid automatic repeat request (HARQ) process, a new data indicator (NDI), a redundancy version, a source identity (ID), a target identity, a HARQ feedback activation/deactivation indicator, and a channel state information (CSI) feedback request.

A second part of SCI format 2-C is related to a resource selection mechanism that is based on coordination between terminal devices. Some standards (e.g., 3GPP R17) introduce two resource selection mechanisms that are based on coordination between terminal devices, which are referred to as Solution 1 and Solution 2 below. In Solution 1, the information transmitted by a terminal device A to a terminal device B is a reference resource set. The reference resource set includes a resource suitable or unsuitable for the terminal device B to use. In Solution 2, the information transmitted by the terminal device A to the terminal device B is: indication information that a collision may occur on reserved resources of the terminal device B.

In Solution 1, the terminal device B may transmit a requesting indicator. The requesting indictor may also be referred to as trigger signaling. The requesting indictor may be used to notify the terminal device A to transmit coordination information to the terminal device B. The terminal device A needs to transmit a providing indicator to the terminal device B. The providing indicator is used to indicate the terminal device A to provide a reference resource set to the terminal device B. Therefore, the providing indicator may also be referred to as a reference resource set indicator. The above requesting indictor and providing indicator are both carried via the SCI format 2-C. Therefore, under different functions, contents of the second part of the SCI format 2-C differ and may be distinguished by a 1-bit “providing/requesting indicator” field. That is, the “providing/requesting indictor” field may be used to indicate whether the SCI format 2-C is used to carry the requesting indictor or the providing indicator.

For example, when the “providing/requesting indictor” field is set to “0”, the SCI format 2-C is used to carry the providing indicator. In the case, as illustrated in FIG. 10, the content of the second part of the SCI format 2-C includes one or more of following information: a providing indicator or a requesting indictor, 2 combinations {a time resource indication value (TRIV), a frequency resource indication value (FRIV), a reservation period}, a time-domain position of a first resource, a reference slot, a resource type, and a frequency-domain position of the first resource.

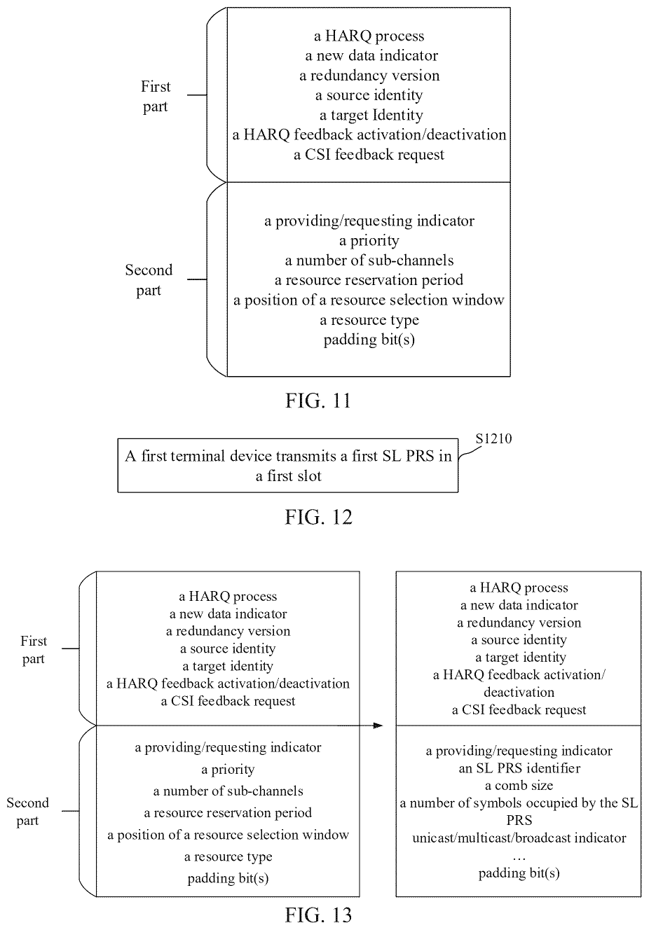

For another example, when the “providing/requesting indictor” field is set to “1”, the SCI format 2-C is used to carry the requesting indictor. In the case, as illustrated in FIG. 11, the second part of the SCI format 2-C includes one or more of following information: a providing indicator or a requesting indictor, a priority, a number of sub-channels, a resource reservation period, a position of a resource selection window, a resource type, and padding bit(s). The reason for setting the padding bit(s) is to ensure that numbers of bits of the SCI format 2-C used to carry different information in a same resource pool are the same. A value of the “padding bit” is generally “0”.

In addition, the SCI format 2-C is transmitted together with a medium access control control element (MAC CE). In the case where the SCI format 2-C is used to carry the requesting indictor, the MAC CE includes information related to the requesting indictor in the SCI format 2-C.

### Positioning Technology Based on Sidelink

The sidelink-based positioning technology is introduced in some communication protocols (e.g., 3GPP R18) as an enhancement scheme of positioning technology. This topic will consider positioning scenarios and requirements, such as within coverage of a cellular network, partial coverage of the cellular network, and outside coverage of the cellular network. In addition, this topic will consider positioning requirements for a V2X usage case, a public safety usage case, a commercial usage case and an industrial internet of things (IIOT) usage case. The sidelink-based positioning technology considers supporting following functions: absolute positioning, ranging/direction finding, and relative positioning. In addition, the sidelink-based positioning technology also considers studying one or more of following: a positioning method that combines a sidelink measurement variable with a Uu interface (i.e., air interface) measurement variable; a sidelink positioning reference signal (including research on signal design, physical layer control signaling, resource assignment, a physical layer measurement variable, and a related physical layer process); and a positioning system architecture and signaling process (such as configuration, measurement reporting).

In the sidelink-based positioning technology, the terminal device needs to transmit an SL PRS to achieve a positioning function. SL PRS transmitted by different terminal devices may be different in time domain, frequency domain and code domain. Therefore, how to ensure other terminal devices to correctly receive the SL PRS is an issue that needs to be studied.

The embodiments of the present disclosure are described hereafter with reference to FIG. 12.

Referring to FIG. 12, in step S1210, a first terminal device transmits a first SL PRS in a first slot. Accordingly, a second terminal device (which may be any one terminal device except the first terminal device) may receive the first SL PRS in the first slot. The first terminal device may be a terminal device that performs positioning based on a sidelink. In response to the first terminal device performing positioning based on the sidelink, the first terminal device may perform step S1210, i.e., transmitting the first SL PRS in the first slot to achieve a positioning function.

The terminal device performing positioning based on the sidelink may operate in either a shared resource pool or a positioning-dedicated resource pool. The so-called shared resource pool means that the resource pool supports both sidelink-based positioning and sidelink communication. The so-called positioning-dedicated resource pool means that the resource pool supports the sidelink-based positioning but does not support the sidelink communication. In some embodiments, the first terminal device in FIG. 12 may be a terminal device operating in the shared resource pool. Alternatively, transmission resources of the first SL PRS are transmission resources in the shared resource pool.

In order to help the second terminal device correctly receive the first SL PRS, transmission configuration information of the first SL PRS may be carried in the first slot. The transmission configuration information of the first SL PRS may include one or more of following information: an identity of the first SL PRS (SL PRS ID); a comb size of frequency-domain resources occupied by the first SL RPS; a number of symbols occupied by the first SL PRS (symbol mentioned in various embodiments of the present disclosure may refer to an orthogonal frequency division multiplexing (OFDM) symbol); and indication information of a transmission manner of the first SL RPS. The indication information of the transmission manner may, for example, indicate that a transmission manner of the first SL RPS is one of unicast, multicast and broadcast.

In some embodiments, the first terminal device may operate in the shared resource pool. In the shared resource pool, there may exist both a terminal device supporting the sidelink positioning-based function and a terminal device without the positioning function. Therefore, in order to ensure compatibility of these two types of terminal devices, the first terminal device may simultaneously transmit first-stage SCI and second-stage SCI in the first slot when transmitting the first SL PRS. A information field included in the first-stage SCI mainly carries information related to sidelink scheduling and channel sensing. A format of the first-stage SCI transmitted simultaneously (i.e., transmitted in a same slot) with the first SL PRS may be the same as a format of the first-stage SCI supporting the sidelink communication. Therefore, the transmission configuration information of the first SL PRS may be carried in the second-stage SCI.

In some embodiments, a format of the second-stage SCI may be indicated by a first information field (i.e., a “second-stage SCI format” field) in the first-stage SCI in the first slot, and a value of the first information field is “10”. In some embodiments, the value of the first information field is “10”, which may represent that the format of the second-stage SCI is SCI format 2-C. If the format of the second-stage SCI adopts this implementation manner, it is possible to avoid introducing a new SCI format, thereby simplifying implementation.

It should be noted that setting the “second-stage SCI format” field in the first-stage SCI to “10” and meanwhile carrying the transmission configuration information of SL PRS in the second-stage SCI is equivalent to adding a function of the SCI format 2-C. Therefore, the SCI format 2-C may also be changed to other names. Therefore, in various embodiments of the present disclosure, the “SCI format 2-C” may be replaced with “a SCI format represented when a value of the first information field in the first-stage SCI (i.e., the “second-stage SCI format” field) is ‘10’ ”. For ease of description, the SCI format 2-C is mainly as an example for description hereafter.

The second-stage SCI may contain one or more information fields (or bit fields, or fields). The one or more information fields may be used to determine whether the first slot contains an SL PRS. For example, the one or more information fields may explicitly indicate that the first slot contains the first SL PRS. For another example, the one or more information fields may implicitly indicate that the first slot contains the first SL PRS.

Taking the format of the second-stage SCI being the SCI format 2-C as an example, the second-stage SCI may include a second information field and/or a third information field. The second information field may be used to indicate a type of information carried by the second-stage SCI. For example, the second information field is used to carry a providing/requesting indicator. The providing indicator in the providing/requesting indicator may also be referred to as a reference resource set indication; and the requesting indictor in the providing/requesting indicator may also be referred to as trigger signaling. For related description, please refer to the “second-stage SCI” section above. The third information field may be used to carry at least one padding bit. In a case where the format of the second-stage SCI is the SCI format 2-C, it may be identified that the first SL PRS exists in the first slot based on the second information field and/or the third information field. For example, the second information field and the third information field may be used to jointly identify that the first SL PRS exists in the first slot. Alternatively, the second information field or the third information field may be used to separately identify that the first SL PRS exists in the first slot.

As an example, if a value of the second information field corresponds to a value of the providing indicator, and a value of a target bit in the at least one padding bit is a first value, it may indicate that the first slot contains the SL PRS. By using the at least one padding bit to indicate whether the first slot contains the SL PRS, the resource utilization rate may be improved.

The target bit may be one or more bits in at least one padding bit. In some embodiments, the target bit may be the last N bits of the at least one padding bit. For example, the target bit may be the last bit of the at least one padding bit. Since a size of the at least one padding bit may vary, by using the last bit of the at least one padding bit to indicate whether the first slot contains the SL PRS, reliability of the indication may be improved.

As an example, in a case where the value of the second information field is 1 and a value of the last bit of the at least one padding bit is 1, it may indicate that the first slot contains the SL PRS. If the at least one padding bit includes multiple bits, values of other bits of the at least one padding bit may be 0. Certainly, the embodiments of the present disclosure do not exclude a case where the value of the last bit of the at least one padding bit is 0 and the values of the other bits are 1, as long as it is agreed in advance through a protocol or the communicating parties.

Alternatively, in some embodiments, the last N bits (such as the last bit) of the second-stage SCI may be set as a new information field (referred to as a fourth information field hereinafter), and based on the fourth information field, it may be indicated or identified that the first slot contains the first SL PRS.

In some embodiments, if the first slot needs to carry the requesting indictor and the first SL PRS at the same time, the configuration information of the first SL PRS may be carried in the second-stage SCI, and information associated with the requesting indictor may be carried in a MAC CE (the MAC CE refers to a MAC CE in a PSSCH to which the second-stage SCI belongs). The information associated with the requesting indictor may include one or more of following information: a priority; a number of sub-channels; a resource reservation period; a position of a resource selection window; and a resource type.

In some embodiments, in a case where the second-stage SCI is used to carry the transmission configuration information of the SL PRS, a number of bits contained in the second-stage SCI may be consistent with a number of bits contained in the second-stage SCI that carries related information of the providing/requesting indicator (as illustrated in FIG. 10 or FIG. 11).

As mentioned above, the first terminal device is the terminal device that supports the sidelink-based positioning function. In addition, the first terminal device may also transmit sidelink data with other terminal devices (for example, if the first terminal device operates in the shared resource pool, the first terminal device may perform both sidelink positioning and sidelink data transmission). In some embodiments, the first terminal device may support a simultaneous transmission of sidelink data and an SL PRS. In some other embodiments, the first terminal device is unable to support the simultaneous transmission of the sidelink data and the SL PRS. The so-called simultaneous transmission of the sidelink data and the SL PRS may refer to that the sidelink data and the SL PRS are transmitted in a same slot.

Taking an example that the first terminal device supports the simultaneous transmission of the sidelink data and the SL PRS, and that the first terminal device simultaneously transmits the sidelink data and the first SL PRS in the first slot, if the format of the second-stage SCI used to carry the transmission configuration information of the first SL PRS is the SCI format 2-C, a first part of the second-stage SCI may be used to carry information related to decoding of sidelink data in a PSSCH. The information related to the decoding of the sidelink data in the PSSCH may include, for example, one or more of following information: a hybrid automatic repeat request (HARQ) process, a new data indicator (NDI), a redundancy version, a source identity, a target identity (ID), a HARQ feedback activation/deactivation indicator, and a channel state information (CSI) feedback request. A second part of the second-stage SCI may be used to carry the transmission configuration information of the first SL PRS as mentioned above. In addition, in some embodiments, the second part of the second-stage SCI may also carry the second information field and the third information field as mentioned above. If the second-stage SCI carries the second information field and the third information field, the transmission configuration information of the first SL PRS may be set between the second information field and the third information field. FIG. 13 is a comparison diagram of SCI format 2-C provided in the related art and the SCI format 2-C provided in the embodiments of the present disclosure. It may be seen from FIG. 13 that if the first terminal device simultaneously transmits the sidelink data and the first SL PRS in the first slot, content of the first part of SCI format 2-C remains basically unchanged. Since the second part needs to carry the transmission configuration information of the first SL PRS, content of the second part changes.

Taking an example that the first terminal device is unable to support the simultaneous transmission of the sidelink data and the SL PRS, if the format of the second-stage SCI used to carry the transmission configuration information of the first SL PRS is the SCI format 2-C, the first part of the second-stage SCI may not include following information: a HARQ process, a NDI, a redundancy version, a source identity, a target ID, a HARQ feedback activation/deactivation indicator, and a CSI feedback request. The second part of the second-stage SCI may be used to carry the transmission configuration information of the first SL PRS as mentioned above. In addition, in some embodiments, the second part of the second-stage SCI may also carry the second information field and the third information field as mentioned above. If the second-stage SCI carries the second information field and the third information field, the transmission configuration information of the first SL PRS may be set between the second information field and the third information field. FIG. 14 is a comparison diagram of the SCI format 2-C provided in the related art and the SCI format 2-C provided in the embodiments of the present disclosure. It can be seen from FIG. 14 that the first part of the SCI format 2-C removes information related to demodulating the sidelink data, and content of the second part of the SCI format 2-C is the same as content of the second part of the SCI format 2-C in FIG. 13.

The embodiments of the present disclosure will be described with reference to an example hereafter. It should be noted that the example provided below are merely intended to help those skilled in the art understand the embodiments of the present disclosure, and are not intended to limit the embodiments of the present disclosure to a specific numerical value or a specific scenario illustrated as the example. It is apparent that those skilled in the art may make various equivalent modifications or changes based on the example provided below, and such modifications or changes also fall within a scope of the embodiments of the present disclosure.

### Example 1

In the example, the first terminal device operates in the shared resource pool, and the first terminal device simultaneously transmits the sidelink data and the first SL PRS in the first slot. In addition, the first terminal device simultaneously transmits the first-stage SCI and the second-stage SCI in the first slot. The transmission configuration information of the first SL PRS is carried by the second-stage SCI transmitted from the first terminal device, and the format of the second-stage SCI is the SCI format 2-C. That is, the “second-stage SCI format” field in the first-stage SCI transmitted from the first terminal device is set to “10”.

In a case where the first terminal device transmits the SCI format 2-C(i.e., transmitting the second-stage SCI whose format is the SCI format 2-C), content of the first part of the SCI format 2-C is consistent with the content illustrated in FIG. 10 or FIG. 11. A “providing/requesting indicator” field (corresponding to the second information field above) in content of the second part is reserved, and the “providing/requesting indicator” field is set to “1”. The last part in content of the second part of the SCI format 2-C is still a “padding bit(s)” field (corresponding to the third information field above), and the last bit of the “padding bit(s)” field is set to “1”. Bits between the “providing/requesting indicator” field and the “padding bit(s)” field in content of the second part may be used to carry the transmission configuration information of the first SL PRS.

From a perspective of a receiving side (i.e., the second terminal device above), in a case where the “second-stage SCI format” in the first-stage SCI received by the second terminal is “10”, the second terminal device determines that the second-stage SCI received is the SCI format 2-C. If the “providing/requesting indicator” field of the SCI format 2-C is “0”, the second terminal device determines that the SCI format 2-C is used to carry the providing indicator. If the last bit of the SCI format 2-C is “0” and the “providing/requesting indicator” field is “1”, the second terminal device determines that the SCI format 2-C is used to carry the requesting indictor. If the last bit of the SCI format 2-C is “1” and the “providing/requesting indictor” field is “1”, the second terminal device determines that an SL PRS exists in the first slot and the transmission configuration information of the SL PRS is carried in the SCI format 2-C.

### Example 2

In the example, the first terminal device operates in the shared resource pool, but the first terminal device is unable to support the simultaneous transmission of the sidelink data and the SL PRS (that is, the first terminal device is unable to transmit both the sidelink data and the SL PRS in a same slot). Therefore, the first terminal device transmits the first SL PRS in the first slot, but does not transmit the sidelink data. It should be noted that the first terminal device being unable to simultaneously transmit the sidelink data and the SL PRS does not mean that the first terminal device does not transmit a PSSCH. In addition to carrying the sidelink data, the PSSCH may also carry second-stage SCI and a MAC CE. Therefore, the first terminal device may still transmit the PSSCH in the first slot to carry the second-stage SCI and the MAC CE.

The first terminal device also simultaneously transmits the first-stage SCI and the second-stage SCI in the first slot. The transmission configuration information of the first SL PRS may be carried by the second-stage SCI, and the format of the second-stage SCI is the SCI format 2-C. That is, the “second-stage SCI format” field in the first-stage SCI transmitted from the first terminal device is set to “10”.

In a case where the first terminal device transmits the SCI format 2-C, the first part of SCI format 2-C no longer contains information such as the HARQ process, the NDI, the redundancy version, the HARQ feedback activation/deactivator, or the CSI feedback request. The “providing/requesting indicator” field (corresponding to the second information field above) in the second part of the SCI format 2-C is reserved, and the “providing/requesting indicator” field is set to “1”. Content of the second part still ends with the “padding bit(s)” field (corresponding to the third information field above), and the last bit of the “padding bit(s)” field is set to “1”. Bits between the “providing/requesting indicator” field and the “padding bit(s)” field in the second part may be used to carry the transmission configuration information of the first SL PRS.

From the perspective of the receiving side (i.e., the second terminal device above), in a case where the “second-stage SCI format” in the first-stage SCI received by the second terminal device is “10”, the second terminal device determines that the second-stage SCI received is the SCI format 2-C. If the “providing/requesting indicator” field of the SCI format 2-C is “0”, the first terminal device determines that the SCI format 2-C is used to carry the providing indicator. If the last bit of the SCI format 2-C is “0” and the “providing/requesting indicator” field is “1”, the second terminal device determines that the SCI format 2-C is used to carry the requesting indictor. If the last bit of the SCI format 2-C is “1” and the “providing/requesting indictor” field is “1”, the second terminal device determines that an SL PRS exists in the first slot and the transmission configuration information of the SL PRS is carried in the SCI format 2-C

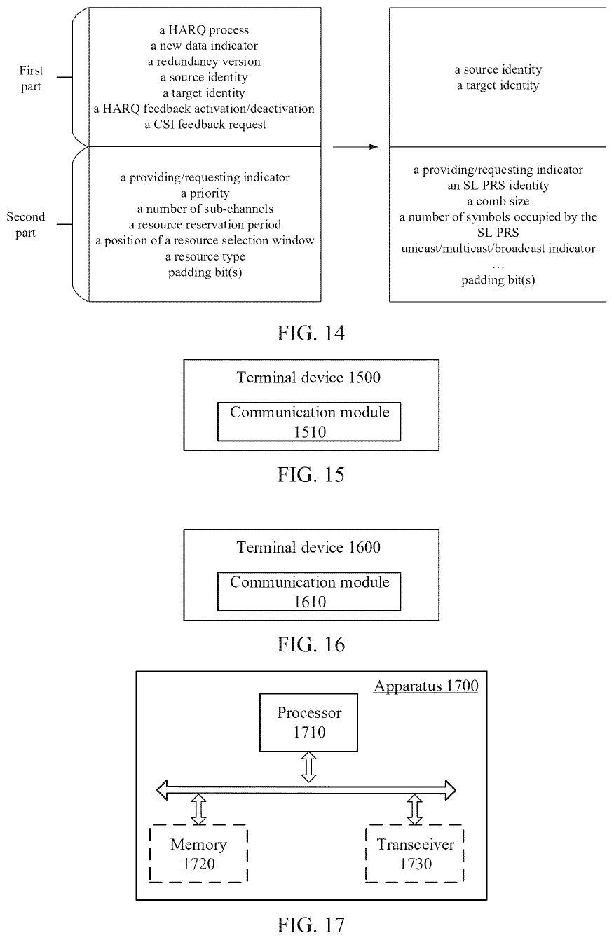

The method embodiments of the present disclosure are described with reference to FIG. 1 to FIG. 14, and apparatus embodiments of the present disclosure will be described below with reference to FIG. 15 to FIG. 17. It should be understood that description of the method embodiments corresponds to description of the apparatus embodiments, and therefore, for parts not described in detail, reference may be made to the method embodiments above.

FIG. 15 is a schematic diagram of a structure of a terminal device provided in an embodiment of the present disclosure. A terminal device 1500 of FIG. 15 may be the first terminal device. The terminal device 1500 may include a communication module 1510.

The communication module 1510 may be configured to transmit a first SL PRS in a first slot. The first slot includes second-stage SCI, and the second-stage SCI includes transmission configuration information of the first SL PRS.

In some embodiments, a format of the second-stage SCI is indicated by a first information field in first-stage SCI in the first slot, and a value of the first information field is 10.

In some embodiments, the second-stage SCI includes one or more information fields, and the one or more information fields are used to determine whether the first slot contains a SL PRS.

In some embodiments, the one or more information fields include one or more of following information fields: a second information field used to carry a providing/requesting indictor; and a third information field used to carry at least one padding bit.

In some embodiments, if a value of the second information field corresponds to a value of the requesting indictor, and a value of a target bit in the at least one padding bit is a first value, the first slot contains the SL PRS; where the target bit is one or more bits in the at least one padding bit.

In some embodiments, the target bit is a last bit of the at least one padding bit; and/or the first value is 1.

In some embodiments, the second-stage SCI is carried in a PSSCH, the PSSCH further includes a MAC CE, the MAC CE includes one or more of following information associated with the requesting indictor: a priority; a number of sub-channels; a resource reservation period; a position of a resource selection window; and a resource type.

In some embodiments, the transmission configuration information includes one or more of the following information: an identity of the first SL PRS; a comb size of frequency-domain resources occupied by the first SL RPS; a number of symbols occupied by the first SL PRS; and indication information of a transmission manner of the first SL PRS; where the transmission manner is one of unicast, multicast and broadcast.

In some embodiments, transmission resources of the first SL PRS are transmission resources in a shared resource pool.

FIG. 16 is a schematic diagram of a structure of a terminal device provided in another embodiment of the present disclosure. A terminal device 1600 of FIG. 16 may be the second terminal device mentioned above. The terminal device 1600 may include a communication module 1610.

The communication module 1610 is configured to receive a first SL PRS in a first slot. The first slot includes second-stage SCI, and the second-stage SCI includes transmission configuration information of the first SL PRS.

In some embodiments, a format of the second-stage SCI is indicated by a first information field in first-stage SCI in the first slot, and a value of the first information field is 10.

In some embodiments, the second-stage SCI includes one or more information fields, and the one or more information fields are used to determine whether the first slot contains an SL PRS.

In some embodiments, the one or more information fields include one or more of following information fields: a second information field used to carry a providing/requesting indictor; and a third information field used to carry at least one padding bit.

In some embodiments, if a value of the second information field corresponds to a value of the requesting indictor and a value of a target bit in the at least one padding bit is a first value, the first slot includes the SL PRS.

In some embodiments, the target bit is a last bit of the at least one padding bit; and/or the first value is 1.

In some embodiments, the second-stage SCI is carried in a physical sidelink shared channel (PSSCH), and the PSSCH further includes a MAC CE, and the MAC CE includes one or more of following information associated with the requesting indictor: a priority; a number of sub-channels; a resource reservation period; a position of a resource selection window; and a resource type.

In some embodiments, the transmission configuration information includes one or more of following information: an identity of the first SL PRS; a comb size of frequency-domain resources occupied by the first SL RPS; a number of symbols occupied by the first SL PRS; and indication information of a transmission manner of the first SL PRS; where the transmission manner is one of unicast, multicast and broadcast.

In some embodiments, transmission resources of the first SL PRS are transmission resources in a shared resource pool.

FIG. 17 is a schematic diagram illustrating a structure of an apparatus of the embodiments of the present disclosure. Dashed lines in FIG. 17 indicate that a unit or a module is optional. An apparatus 1700 may be used to implement the method described in the above method embodiments. The apparatus 1700 may be a chip, or a terminal device.

The apparatus 1700 may include one or more processors 1710. The processor 1710 may support the apparatus 1700 to implement the method described in the above method embodiments. The processor 1710 may be a general-purpose processor or a dedicated-purpose processor. For example, the processor may be a central processing unit (CPU). Alternatively, the processor may be other general-purpose processors, a digital signal processor (DSP), an application specific integrated circuit (ASIC), a field programmable gate array (FPGA) or other programmable logic devices, a discrete gate or transistor logic device, a discrete hardware component, etc. The general-purpose processor may be a microprocessor. Alternatively, the processor may be any conventional processor or the like.

The apparatus 1700 may further include one or more memories 1720. The memory 1720 stores a program thereon, which may be executed by the processor 1710, so as to enable the processor 1710 to perform the method described in the above method embodiments. The memory 1720 may be independent of the processor 1710 or may be integrated into the processor 1710.

The apparatus 1700 may further include a transceiver 1730. The processor 1710 may communicate with other devices or chips through the transceiver 1730. For example, the processor 1710 may transmit and receive data from other devices or chips through the transceiver 1730.

The embodiments of the present disclosure further provide a non-transitory computer-readable storage medium for storing a program. The non-transitory computer-readable storage medium may be applied to the terminal device provided in the embodiments of the present disclosure, and the program enables a computer to perform the method performed by the terminal device in various embodiments of the present disclosure.

The embodiments of the present disclosure further provide a computer program product. The computer program product includes a program. The computer program product may be applied to the terminal device provided in the embodiments of the present disclosure, and the program enables a computer to perform the method performed by the terminal device in various embodiments of the present disclosure.

The embodiments of the present disclosure further provide a computer program. The computer program may be applied to the terminal device provided in the embodiments of the present disclosure, and the computer program enables a computer to perform the method performed by the terminal device in various embodiments of the present disclosure.

It should be understood that the terms “system” and “network” in the present disclosure may be used interchangeably. Furthermore, the terms used in the present disclosure are only used to explain the embodiments of the present disclosure and are not intended to limit the present disclosure. The terms “first,” “second,” “third,” “fourth” and the like in the specification, claims and drawings of the present disclosure are used to distinguish different objects rather than to describe a specific order. Furthermore, the terms “include/comprise,” “has/having,” and any variations thereof, are intended to cover a non-exclusive inclusion.

In the embodiments of the present disclosure, the “indicate/indicated/indicating/indication” mentioned may be a direct indication, an indirect indication, or may mean that there is an indication of an associated relationship. For example, A indicating B may mean that A directly indicates B, for example, B may be obtained by A; alternatively, A indicating B may mean that A indirectly indicates B, for example, A indicates C, and B may be obtained by C; alternatively, A indicating B may mean that there is an association relationship between A and B.

In the embodiments of the present disclosure, “B corresponding to A” means that B is associated with A, and B may be determined based on A. However, it should also be understood that determining B based on A does not mean determining B based on A only, and B may also be determined based on A and/or other information.

In the embodiments of the present disclosure, the term “correspond/corresponding/correspondence” may indicate a direct correspondence or an indirect correspondence between the two, or may mean that there is an association relationship between the two, or may mean a relationship of indicating and being indicated, or a relationship of configuring and being configured, or the like.

In the embodiments of the present disclosure, “pre-defined” or “pre-configured” may be achieved by pre-storing, in a device (for example, including the terminal device and the network device), a corresponding code, a table or other manners that may be used to indicate relevant information, and an implementation manner thereof is not limited in the present disclosure. For example, pre-defined may refer to being defined in a protocol.

In the embodiments of the present disclosure, the “protocol” may refer to a standard protocol in the communication field. For example, the “protocol” may include an LTE protocol, an NR protocol, and a related protocol used in a future communication system, which is not limited in present disclosure.

In the embodiments of the present disclosure, the term “and/or” is merely an association relationship to describe associated objects, which indicates that three kinds of relationships may exist. For example, “A and/or B” may mean three cases as follows: A exists alone, both A and B exist, or B exists alone. In addition, a character “/” in the present disclosure usually indicates that the associated objects before and after the “/” are in an “or” relationship.

In various embodiments of the present disclosure, values of serial numbers of the aforementioned processes do not mean an execution order. The execution order of each process shall be determined by its function and internal logic, and shall not impose any limitations on an implementation process of the embodiments of the present disclosure.

It should be understood that the disclosed systems, apparatuses, and methods in several embodiments provided in the present disclosure may be implemented in other ways. For example, the apparatus embodiments described above are merely exemplary only. For example, a division of units is merely a division based on logical functions while other division manners exist in an actual implementation. For example, a plurality of units or components may be combined or integrated into another system, or some characteristics may be omitted or skipped. Furthermore, the displayed or discussed mutual coupling, direct coupling or communicative connection through some ports, apparatuses, or units whether indirectly or communicatively by ways of electrical, mechanical, or other kinds of forms.

The units described as separating components may or may not be physically separated, and components as units for display may or may not be physical units. That is, they may be located in a place or distributed on a plurality of network units. Some or all of the units may be selected according to actual needs to achieve the purpose of the solution of the embodiments.

Furthermore, various function units in various embodiments of the present disclosure may be integrated into a processing unit, or be physically independent. Alternatively, two or more than two units are integrated in one processing unit.

All or some of the above embodiments may be implemented by software, hardware, firmware or any combination thereof. When implemented using software, all or some of embodiments may be implemented in a form as a computer program product. The computer program product includes one or more computer instructions. When the computer program instructions are loaded and executed on a computer, all or some processes or functions described in the embodiments of the present disclosure are generated. The computer may be a general-purpose computer, a dedicated-purpose computer, a computer network, or other programmable devices. The computer instructions may be stored in a non-transitory computer-readable storage medium. Alternatively, the computer instructions may be transmitted from a non-transitory computer-readable storage medium to another non-transitory computer-readable storage medium. For example, the computer instructions may be transmitted from a website, a computer, a server, or a data center to another website, another computer, another server, or another data center via a wired manner (e.g., a coaxial cable, optical fiber, a digital subscriber line (DSL)) or a wireless manner (e.g., an infrared or radio manner, microwave, etc.). The non-transitory computer-readable storage medium may be any available medium that can be read by a computer, or the non-transitory computer-readable storage medium may be a data storage device such as the server or the data center that includes one or more available mediums. The available medium may be a magnetic medium (e.g., a floppy disk, a hard disk, a magnetic tape), an optical medium (e.g., a digital video disc (DVD)), or a semiconductor medium (e.g., a solid state disk (SSD)), etc.

The above description is only an exemplary implementation manner of the present disclosure, but the protection scope of the present disclosure is not limited thereto. Any person skilled in the art familiar with the technical field may easily think of a change or a substitution within the technical scope disclosed in the present disclosure, which shall be covered by the protection scope of the present disclosure. Therefore, the protection scope of the present disclosure shall be subject to the protection scope of the claims.

What is claimed is:

1. A wireless communication method, comprising:
transmitting, by a first terminal device, a first sidelink positioning reference signal (SL PRS) in a first slot; wherein the first slot comprises second-stage sidelink control information (SCI), and the second-stage SCI comprises transmission configuration information of the first SL PRS.

2. The method according to claim 1, wherein a format of the second-stage SCI is indicated by a first information field in first-stage SCI in the first slot, and a value of the first information field is 10;
wherein the second-stage SCI comprises one or more information fields, and the one or more information fields are used to determine whether the first slot contains an SL PRS.

3. The method according to claim 2, wherein the one or more information fields comprise one or more of following information fields:
a second information field, used to carry a providing indicator or a requesting indictor; and
a third information field, used to carry at least one padding bit.

4. The method according to claim 3, wherein
if a value of the second information field corresponds to a value of the requesting indictor, and a value of a target bit in the at least one padding bit is a first value, the first slot contains the SL PRS; wherein the target bit is one or more bits in the at least one padding bit;
wherein the target bit is a last bit of the at least one padding bit; and/or
the first value is 1.

5. The method according to claim 3, wherein the second-stage SCI is carried in a physical sidelink shared channel (PSSCH), the PSSCH further comprises a medium access control control element (MAC CE), and the MAC CE comprises one or more of following information associated with the requesting indicator:
a priority;
a number of sub-channels;
a resource reservation period;
a position of a resource selection window; and
a resource type.

6. The method according to claim 1, wherein the transmission configuration information comprises one or more of following information:
an identity of the first SL PRS;
a comb size of frequency-domain resources occupied by the first SL RPS;
a number of symbols occupied by the first SL PRS; and
indication information of a transmission manner of the first SL PRS;
wherein the transmission manner is one of unicast, multicast and broadcast.

7. The method according to claim 1, wherein transmission resources of the first SL PRS are transmission resources in a shared resource pool.

8. A wireless communication method, comprising:
receiving, by a second terminal device, a first sidelink positioning reference signal (SL PRS) in a first slot; wherein the first slot comprises second-stage sidelink control information (SCI), and the second-stage SCI comprises transmission configuration information of the first SL PRS.

9. The method according to claim 8, wherein a format of the second-stage SCI is indicated by a first information field in first-stage SCI in the first slot, and a value of the first information field is 10;
wherein the second-stage SCI comprises one or more information fields, and the one or more information fields are used to determine whether the first slot contains an SL PRS.

10. The method according to claim 9, wherein the one or more information fields comprise one or more of following information fields:
a second information field, used to carry a providing indicator or a requesting indictor; and
a third information field, used to carry at least one padding bit.

11. The method according to claim 10, wherein
if a value of the second information field corresponds to a value of the requesting indictor and a value of a target bit in the at least one padding bit is a first value, the first slot contains the SL PRS; wherein the target bit is one or more bits in the at least one padding bit;
wherein the target bit is a last bit of the at least one padding bit; and/or
the first value is 1.

12. The method according to claim 10, wherein the second-stage SCI is carried in a physical sidelink shared channel (PSSCH), the PSSCH further comprises a medium access control control element (MAC CE), and the MAC CE comprises one or more of following information associated with the requesting indictor:
a priority;
a number of sub-channels;
a resource reservation period;
a position of a resource selection window; and
a resource type.

13. The method according to claim 8 wherein the transmission configuration information comprises one or more of following information:
an identity of the first SL PRS;
a comb size of frequency-domain resources occupied by the first SL RPS;
a number of symbols occupied by the first SL PRS; and
indication information of a transmission manner of the first SL PRS;
wherein the transmission manner is one of unicast, multicast and broadcast.

14. The method according to claim 8, wherein transmission resources of the first SL PRS are transmission resources in a shared resource pool.

15. A terminal device, comprising a transceiver, a memory and a processor, wherein the memory is configured to store a program, and the processor is configured to call the program in the memory and control the transceiver to receive or transmit a signal, to enable the terminal device to perform:
transmitting a first sidelink positioning reference signal (SL PRS) in a first slot; wherein the first slot comprises second-stage sidelink control information (SCI), and the second-stage SCI comprises transmission configuration information of the first SL PRS.

16. The terminal device according to claim 15, wherein a format of the second-stage SCI is indicated by a first information field in first-stage SCI in the first slot, and a value of the first information field is 10;
wherein the second-stage SCI comprises one or more information fields, and the one or more information fields are used to determine whether the first slot contains an SL PRS.

17. The terminal device according to claim 16, wherein the one or more information fields comprise one or more of following information fields:
a second information field, used to carry a providing indicator or a requesting indictor; and
a third information field, used to carry at least one padding bit.

18. The terminal device according to claim 17, wherein
if a value of the second information field corresponds to a value of the requesting indictor, and a value of a target bit in the at least one padding bit is a first value, the first slot contains the SL PRS; wherein the target bit is one or more bits in the at least one padding bit;
wherein the target bit is a last bit of the at least one padding bit; and/or
the first value is 1;
and/or
the second-stage SCI is carried in a physical sidelink shared channel (PSSCH), the PSSCH further comprises a medium access control control element (MAC CE), and the MAC CE comprises one or more of following information associated with the requesting indicator:
a priority;
a number of sub-channels;
a resource reservation period;
a position of a resource selection window; and
a resource type.

19. The terminal device according to claim 15, wherein the transmission configuration information comprises one or more of following information:
an identity of the first SL PRS;
a comb size of frequency-domain resources occupied by the first SL RPS;
a number of symbols occupied by the first SL PRS; and
indication information of a transmission manner of the first SL PRS;
wherein the transmission manner is one of unicast, multicast and broadcast.

20. The terminal device according to claim 15, wherein transmission resources of the first SL PRS are transmission resources in a shared resource pool.
